(19) United States
(12) Patent Application Publication
(10) Pub. No.: US 2007/0236330 A1
(43) Pub. Date: Oct. 11, 2007

(54) System and method for performing user authentication based on user behavior patterns

(76) Inventors: Sungzoon Cho, Seoul (KR); Min Jang, Seoul (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/651,132

(22) Filed: Jan. 9, 2007

(30) Foreign Application Priority Data
Apr. 6, 2006 (KR) 2006-31215

(51) Int. Cl. G05B 19/00

(52) U.S. Cl. 340/5.54

(57) ABSTRACT

A system and method for performing user authentication based on behavior patterns of a mobile terminal user is disclosed. The system includes a mobile terminal having an input unit configured to receive authentication information from a user, an authentication unit configured to extract behavior patterns of the user based on the authentication information, and a data communication unit configured to transmit the authentication information and the behavior patterns to an authentication server. The behavior patterns extracted based on the authentication information includes the user's characteristic behavior patterns such as typing patterns, motion patterns, voice patterns and writing patterns. Such behavior patterns represent both the authentication information and the behavior characteristics of the user, which increases the security level of the system. The authentication server may perform two stages of user authentication processes. In a first user authentication stage, the authentication server compares the received authentication information with those stored in an authentication information database. If a claimed identity of a user is verified at the first user authentication stage, then a second user authentication stage may be performed by comparing the received behavior patterns with those stored in the authentication information database.

### CROSS REFERENCE TO RELATED APPLICATIONS

This application is based upon and claims priority from Korean Patent Applications No. 2006-31215, filed on Apr. 6, 2006; the entire contents of which are incorporated herein by reference.

### TECHNICAL FIELD

The present disclosure generally relates to a system and method for performing user authentication based on user behavior patterns, and more particularly to a system and method for performing user authentication based on user behavior patterns such as motion and typing patterns of a user, in addition to conventional authentication information such as a password associated with an ID of the user, thereby improving security and mobility of a user authentication system.

### BACKGROUND

In electronic commerce services such as Internet-based online banking, stock trading and billing services, a user authentication process is required to verify an identify claimed by a user. In general, the user authentication process is performed by comparing an ID and a password inputted by a user with IDs and passwords (i.e., template IDs and passwords) enrolled in a database of an authentication system. Although such password approach is most widely used because of being the simplest and least expensive tool, it has drawbacks in that people tend to choose as passwords such easy-to-guess words and/or number as the names of family members, birthdays, phone numbers, addresses, etc. Particularly, in case a user accesses a main service providing system through a mobile terminal such as a mobile phone having a small-sized key pad, the user usually uses only a very limited set of numeric characters (typically a sequence of 4 to 6 numbers) as his/her password. Therefore, a user authentication method, which replaces or consolidates the password approach, is required to improve security of a user authentication system especially in a mobile network environment.

In order to address the above-described problem, biometrics has been suggested for performing more accurate user authentications. Biometrics refers to a method of identifying a person based on his/her physiological or behavioral characteristics. Such method of identification is preferable over the conventional password methods for the reasons that (i) the person to be identified must be physically present at the point of identification; and (ii) the identification using the biometric techniques does not require any password.

In general, biometrics is performed based on a user's physiological characteristics such as fingerprints, facial features, irises, palm prints, etc. Such physiological characteristics are unique to an individual and are consistently preserved over time, thereby serving as highly reliable and accurate forms of identification. However, the biometrics based on physiological characteristics does not depend on the user's behavior, but rather heavily depends upon the input device involved. Thus, in order to improve the accuracy of identification, the overall costs of the biometrics system must inevitably increase. On the other hand, behavioral biometrics such as keystroke dynamics has various advantages such as low cost, user-friendliness and facilitated remote access control. The keystroke dynamics refer to a method of how a user types a password at an input device (e.g., keyboard) of a user authentication system.

There is needed a system and method for combining behavioral biometrics into a conventional password approach, to improve security and mobility of a user authentication system. Further, in order to improve accuracy of the user authentication system it is more desirable to perform user authentication based on various behavior patterns including motion patterns and voice patterns as well as behavioral biometrics such as typing patterns.

### SUMMARY

The present disclosure is directed to a system and method for performing user authentication based on behavior patterns of a user.

In accordance with one embodiment, a mobile terminal includes an input unit configured to receive authentication information of a user, an authentication unit configured to extract behavior patterns based on the authentication information, and a data communication unit configured to transmit the authentication information and the behavior patterns to an authentication server. The authentication server is configured to verify an identity of the user by comparing at least one of the authentication information and the behavior patterns with template authentication information and behavior patterns.

The input unit of the mobile terminal may include a key pad configured to receive keystrokes typed by the user, a motion sensor configured to receive signals generated by moving the mobile terminal, a camera configured to capture an image of the user's motion, a microphone configured to input the user's voice, or a signature input device configured to input the user's signature.

In another embodiment, a system for performing user authentication includes a database configured to store template authentication information and behavior patterns associated with the template authentication information, an input unit configured to receive test authentication information and behavior patterns from a mobile terminal of a user, and an authentication unit configured to verify an identity of the user by comparing at least one of the test authentication information and behavior patterns with the template authentication information and behavior patterns stored in the database.

The system may perform two stages of user authentication processes: a first authentication stage for verifying an identity of the user by comparing the test authentication information with the template authentication information stored in the database; and a second authentication stage for verifying an identity of the user by comparing the test behavior patterns with the template behavior patterns stored in the database, if the verification of the identity of the user succeeds in the first authentication stage.

In still another embodiment, there is provided a method for enrolling authentication information. The method includes the operations of receiving authentication information from a user, and checking if the user has chosen to use behavior patterns associated with the authentication information in verifying an identity of the user. If it is determined that the user has chosen to use the behavior patterns, the behavior patterns are extracted based on the authentication information, and the authentication information and the extracted behavior patterns are stored in a database.

The method may further includes the operation of receiving information on a type of the behavior patterns and tolerance values associated with the behavior patterns, wherein the tolerance values to be used as a margin of error in verifying an identity of the user.

In yet another embodiment, a method for performing user authentication in a mobile terminal is provided. The method includes the operations of receiving test authentication information from a user of the mobile terminal, extracting test behavior patterns based on the test authentication information, requesting for user authentication by transmitting the test authentication information and behavior patterns to an authentication server, and receiving a result of the verification from the authentication server. The authentication server is configured to verify an identity of the user by comparing at least one of the test authentication information and behavior patterns with template authentication information and behavior patterns.

In a further embodiment, there is provided a method for performing user authentication in an authentication server. The method includes the operations of receiving test authentication information and behavior patterns extracted based on the test authentication information from a mobile terminal, and performing a first authentication stage by comparing the test authentication information with template authentication information stored in a database. In the method, if the first user authentication succeeds, it is checked if a second authentication stage is required. Then, if it is determined that the second authentication stage is required, the test behavior patterns are compared with template behavior patterns stored in the database. Further, at least one of results of the first and second authentication stages may be transmitted to the mobile terminal.

### BRIEF DESCRIPTION OF THE DRAWINGS

The present disclosure may best be understood by reference to the following detailed description when considered in connection with the accompanying drawings:

FIG. 1 illustrates a configuration of a user authentication system in accordance with one embodiment of the present disclosure;

FIG. 2 shows a detailed configuration of a user authentication system including a mobile terminal connected to an authentication server in accordance with one embodiment of the present disclosure;

FIG. 3 depicts a configuration of an input unit included in a mobile terminal in accordance with one embodiment of the present disclosure;

FIGS. 4A to 4E set forth graphs of exemplary typing patterns including durations, pressures, intervals and latencies of keystrokes typed by a user in accordance with one embodiment of the present disclosure;

FIG. 5 shows a procedure for inputting a password by moving a mobile terminal in accordance with one embodiment of the present disclosure;

FIG. 6 presents a configuration of a data structure including authentication information and behavior patterns, which is stored in an authentication information database in accordance with one embodiment of the present disclosure;

FIG. 7 illustrates a flowchart of a method for enrolling authentication information and behavior patterns in accordance with one embodiment of the present disclosure;

FIGS. 8A and 8B depict graphical user interfaces for enrolling authentication information and behavior patterns in a mobile terminal in accordance with one embodiment of the present disclosure;

FIG. 9 sets forth a flowchart of a method for performing user authentication in a mobile terminal in accordance with one embodiment of the present disclosure; and

FIG. 10 describes a flowchart of a method for performing user authentication in an authentication server in accordance with one embodiment of the present disclosure.

### DETAILED DESCRIPTION

In the following description, numerous specific details are set forth. It will be apparent, however, that these embodiments may be practiced without some or all of these specific details. In other instances, well known process operations or elements have not been described in detail in order not to unnecessarily obscure the present disclosure.

The present disclosure is directed to a system and method for performing user authentication based on behavior patterns of a mobile terminal user. In one embodiment, the system includes a mobile terminal having an input unit for receiving authentication information from a user, an authentication unit for extracting behavior patterns of the user based on the authentication information, and a data communication unit for transmitting the authentication information and the behavior patterns to an authentication server. The input unit of the mobile terminal may include one or more input devices such as a key pad, a motion sensor, a microphone, a touch screen and a camera, which receives the authentication information (e.g., an ID and a password associated with the ID) in forms of keystrokes, motions, voice and signatures. Such input devices may be installed in the mobile terminal as a built-in component or may be connected to the mobile terminal through a wired/wireless connection. The behavior patterns are extracted based on the authentication information received by the input unit, which include, but not limited to, the user's characteristic behavior patterns such as typing patterns, motion patterns, voice patterns and writing patterns. Such behavior patterns represent both the authentication information and the behavior characteristics of a user, which increases a security level of the system.

In one embodiment, the authentication server includes a data communication unit for receiving the authentication information and behavior patterns from the mobile terminal, an authentication information database for storing template authentication information and relevant behavior patterns, and an authentication unit for performing user authentication by comparing the received authentication information and/or behavior patterns with the template authentication information and/or behavior patterns stored in the database. The database may further include a behavior user authentication flag on whether behavior user authentication is performed based on behavior patterns and tolerance values (i.e., margin of error) associated with the behavior patterns.

The authentication server may perform one or both of two stages of user authentication processes depending on the behavior user authentication flag. At a primary user authentication stage, the authentication unit of the authentication server compares the received authentication information with those stored in the authentication information database. If a claimed identity of a user is verified at the primary user authentication stage and the behavior user authentication flag is set to be on, then a behavior user authentication stage is performed by comparing the received behavior patterns with those stored in the authentication information database.

In the following sections, several embodiments in accordance with the above-described principles of the present disclosure will be described in detail with reference to the drawings.

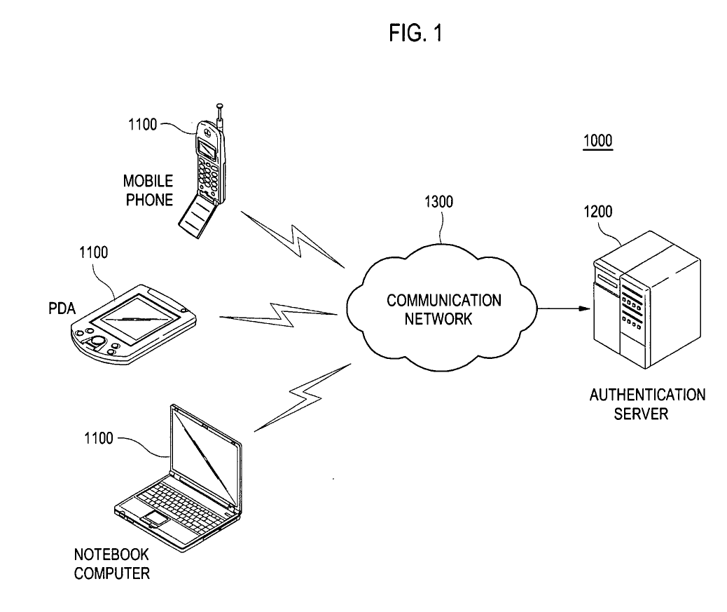

FIG. 1 illustrates a configuration of a user authentication system in accordance with one embodiment of the present disclosure. As shown in FIG. 1, the user authentication system 1000 includes at least one mobile terminal 1100 for receiving authentication information including an ID and a password from a user and extracting behavior patterns based on the authentication information. Further, an authentication server 1200 is connected to the mobile terminal 1100 through a communication network 1300, which performs user authentication based on the authentication information and/or the behavior patterns received from the mobile terminal 1100. It should be noted that the mobile terminal 1100 may be any type of portable device having mobile communication capability such as a cellular phone, PDA (personal digital assistant), laptop, and the like. Further, the communication network 1300 may be any type of wireless data network, e.g., employing CDMA, TDMA, GSM technologies, the Internet or any combination of wireless and wired data networks.

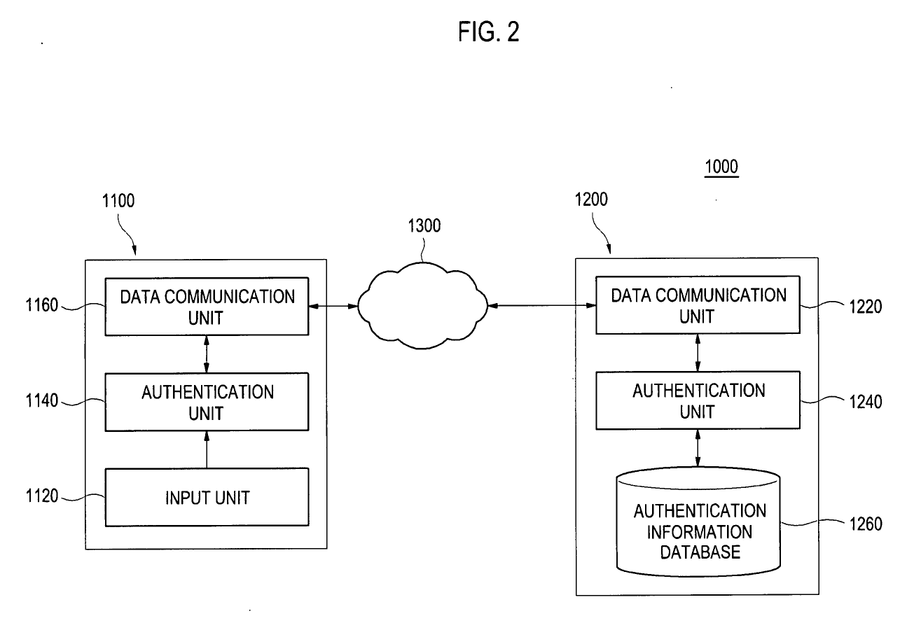

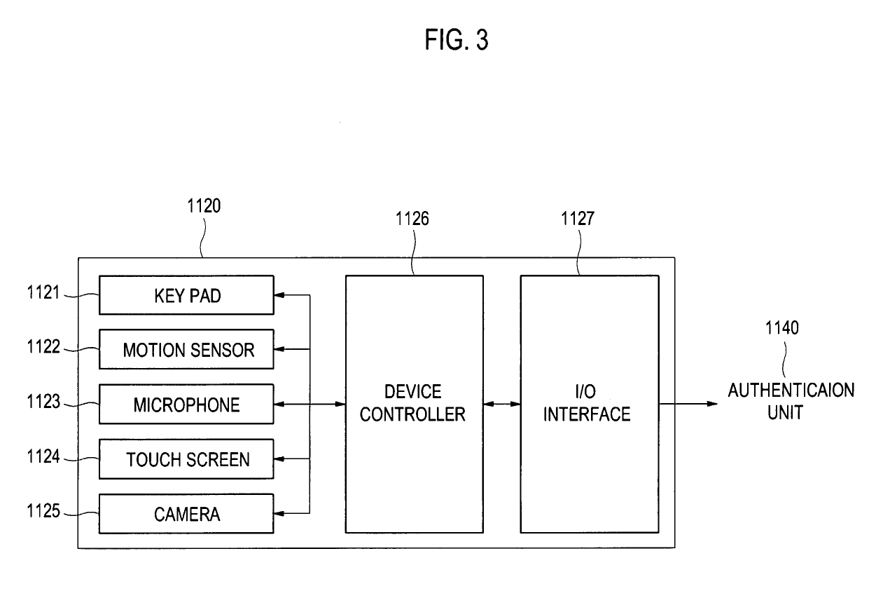

FIG. 2 depicts a detailed configuration of the user authentication system 1000 as shown in FIG. 1. The mobile terminal 1100 includes an input unit 1120, an authentication unit 1140 and a data communication unit 1160. The input unit 1120 receives authentication information from a user and sends the received authentication information to the authentication unit 1140. As shown in FIG. 3, the input unit 1120 may include an I/O interface 1127 for transmitting data from a device controller 1126 to the authentication unit 1140, the device controller 1126 for controlling the operation of input devices or sensors such as a keypad 1121, a motion sensor 1122, a microphone 1123, a touch screen 1124 and a camera 1125. For example, the device controller 1126 receives a control signal from the authentication unit 1140 to control the operation of the input devices or sensors, and preprocesses and converts analog signals received from the input devices into digital signals representing authentication information, which are fed to the authentication unit 1140 through the I/O interface 1127. The authentication unit 1140 then extracts behavior patterns based on the authentication information received from the input unit 1120.

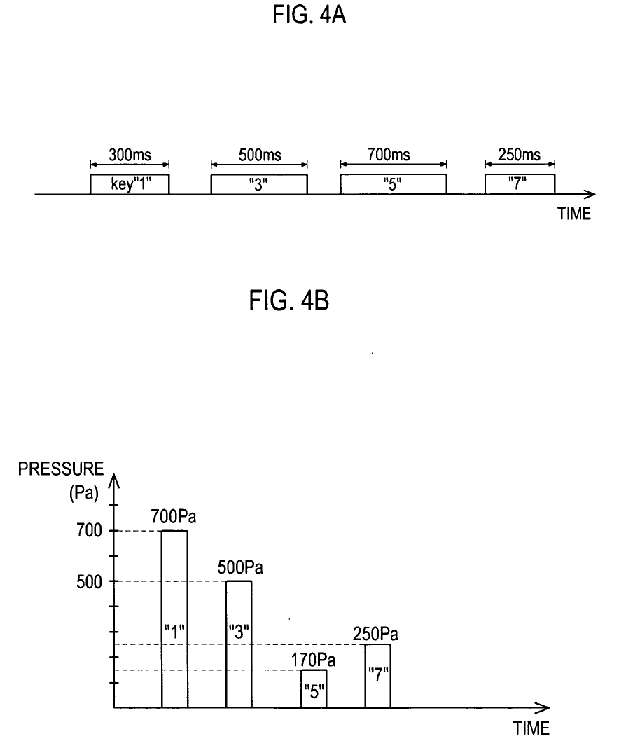

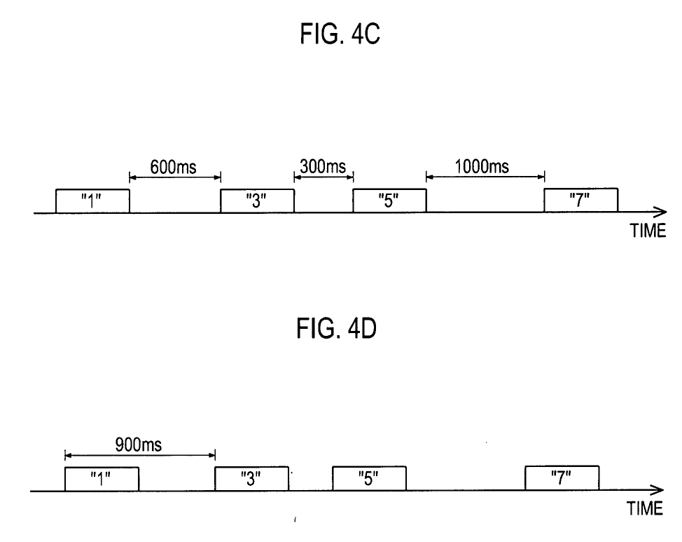

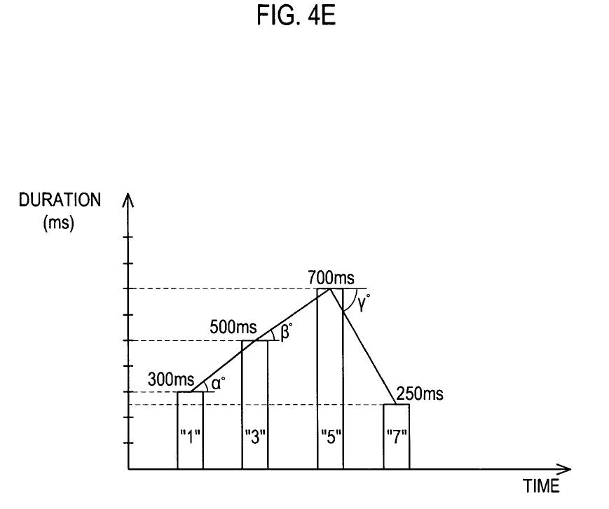

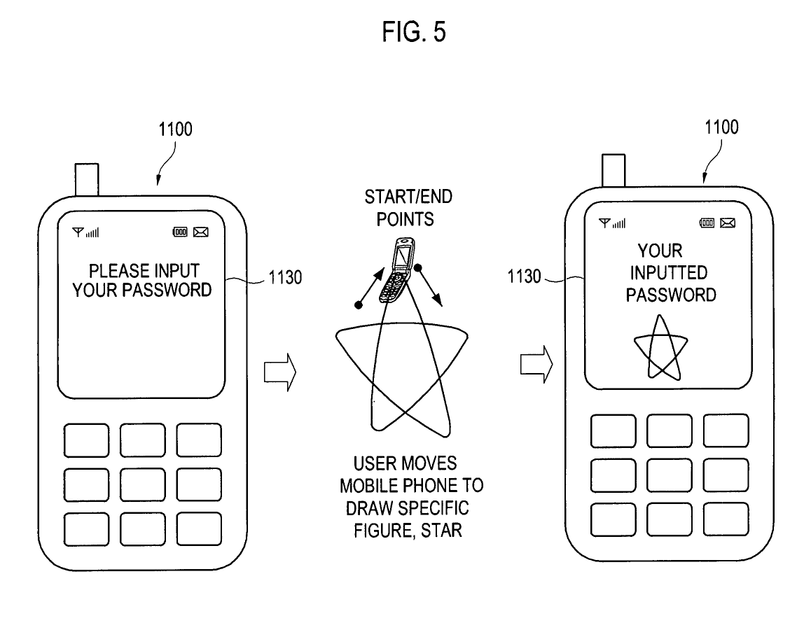

In the following, examples of user's behavior patterns extracted by the authentication unit 1140 will be described in detail with reference to FIGS. 4A to 4E and FIG. 5.

In one embodiment, the authentication unit 1140 of the mobile terminal 1100 extracts typing patterns based on the authentication information inputted through the keypad 1121. For example, if a user inputs his/her ID and password through the keypad 1121, the authentication module 1140 can extracts typing patterns based on keystrokes of the inputted ID and/or password. The typing patterns may be represented by at least one of three distinct variables, namely, duration (i.e., amount of time a user holds down a particular key), interval (i.e., amount of time it takes a user to type between keys), or pressure (i.e., amount of pressure at which a user holds down a particular key).

FIGS. 4A to 4E illustrate graphs showing example typing patterns extracted by the authentication unit 1140 of the mobile terminal 1100 when a user types a sequence of numbers, “1, 3, 5, 7” as a password through the keypad 1121.

As shown in FIG. 4A, if a user holds down keys corresponding to the numbers, “1, 3, 5, 7” for durations 300 ms, 500 ms, 700 ms and 250 ms, respectively, at least one part of the sequence of durations, “300, 500, 700, 250” can be used as typing patterns. The sequence of durations measured by the input unit 1120 may be converted into another form of values through the device controller 1126 before being transmitted to the authentication unit 1140. Depending on the security level required by the authentication system, the durations may be quantized into values of various resolutions. For example, if the authentication system requires a very low level of security, each of the durations can be converted into one of two binary values, ‘0’ and ‘1’, based on a predetermined threshold, e.g., 500 ms. In this case, the sequence of durations, “300, 500, 700, 250” can be converted into a sequence of binary numbers “0, 1, 1, 0,” which are then transmitted to the authentication unit 1140 of the mobile terminal 1100. On the other hand, if a higher level of security is required in the authentication system, the durations can be quantized into values of higher resolution.

Further, the input units 1120 of the mobile terminal 1100 may measure pressure at which a user holds down keys to type an ID and/or a password. In this case, the input units 1120 may further include a sensor for measuring the pressure of holding down keys of the key pad 1121. For example, as shown in FIG. 4B, if a user types a sequence of numbers “1, 3, 5, 7” through the key pad 1121 at pressures 700 Pa, 500 Pa, 170 Pa and 250 Pa, respectively, a sequence of pressure values “700, 500, 170, 250” or at least one part thereof may be used as typing patterns. As mentioned above, depending on the security level required by the authentication system, the measured pressure values may be quantized into values of various resolutions.

Also, the input units 1120 of the mobile terminal 1100 may measure interval between keys a user types. For example, as shown in FIG. 4C, if a user types a sequence of numbers “1, 3, 5, 7” through the key pad 1121 with intervals 600 ms, 300 ms and 1000 ms, respectively, a sequence of interval values “600, 300, 1000” or at least one part thereof may be used as typing patterns. Similarly, depending on the security level required by the authentication system, the measured interval values may be quantized into values of various resolutions.

In one embodiment, as shown in FIG. 4D, duration (hereinafter referred to as “latency”) from a time of pressing a key to a time of pressing a subsequent key may be measured as typing patterns. Alternatively, typing patterns may be extracted from geometrical relations between values of duration, pressure and latency measured by the input unit 1120. For example, as shown in FIG. 4E, the values of measured duration may be plotted in a line graph, such that an angle (e.g., α°, β°, γ°) between a line segment connecting two subsequent values and an x-axis can be used as typing patterns. Further, the typing patterns extracted from the authentication information are not limited to the above examples, i.e., duration, pressure and latency, but a combination of the above-described typing patterns may be used to represent typing patterns for the authentication information.

In one embodiment, the authentication unit 1140 of the mobile terminal 1100 extracts behavior patterns based on authentication information inputted through the motion sensor 1122. The motion sensor 1122 may include any type of device for recognizing a user's motion, e.g., a two- or three-axis magnetic field sensor or a wearable device such as a data glove. For example, if a user moves the mobile terminal 1100 to indicate his/her ID and password, the motion sensor 1122 can extract therefrom behavior patterns, i.e., various characteristics of the user's motion. Particularly, the behavior patterns may be represented by at least one of distance, direction and velocity of the user's motion.

FIG. 5 describes an example procedure where a user inputs a password by moving a mobile terminal according to an instruction displayed on the mobile terminal. For example, after a user inputs an ID through a keypad on the mobile terminal 1100, the mobile terminal 1100 presents an instruction to input a password on a display unit 1130. Then, according to the instruction displayed on the display unit 1130, a user starts to move the mobile terminal 1100 to draw a specific figure, e.g., a star, as a password. The user may push a specific button on the mobile terminal 1100 to indicate the completion of inputting the password. Thereafter, the display unit 1130 of the mobile terminal 1100 displays an image of a motion trajectory captured by the motion sensor 1122, and then proceeds to perform user authentication based on behavior patterns extracted based on the captured motion. For example, the behavior patterns extracted based on the captured motion includes at least one of two- or three-dimensional coordinates of the motion trajectory and speed or duration of the motion.

In another embodiment, the authentication unit 1140 of the mobile terminal 1100 extracts behavior patterns based on authentication information inputted through the microphone 1123. Particularly, the microphone 1123 of the mobile terminal 1100 records a user's voice when the user speaks an ID and/or a password. The behavior patterns extracted based on the user's voice include inherent characteristics such as tones as well as acquired or intentionally created characteristics such as speed and intonation. In one embodiment, the acquired characteristics of the voice may be used as behavior patterns to verify the user's identity. A user may pronounce an ID and/or a password in a different way from normal. For example, the user may pronounce a specific part of a password longer or louder than the other parts. Such behavior patterns may be extracted based on the recorded voice using any suitable voice analysis algorithms.

In one embodiment, the authentication unit 1140 of the mobile terminal 1100 extracts behavior patterns based on authentication information inputted through the touch screen 1124. A user may input a signature representing an ID and/or a password on the touch screen 1124 using a stylus. Then, the input unit 1120 extracts behavior patterns from the inputted signature such as a trajectory of the signature over time, variations of pressure or speed at which the user inputs the signature. Such behavior patterns extracted from the signature include inherent characteristics as well as acquired or intentionally created characteristics of the signature.

In another embodiment, the authentication unit 1140 of the mobile terminal 1100 extracts behavior patterns based on authentication information inputted through the camera 1125. Particularly, the camera 1125 of the mobile terminal 1100 may capture still or moving pictures of a user's motion representing the authentication information, from which the authentication unit 1140 can extract behavior patterns. For example, the behavior patterns may be represented by at least one of a trajectory, direction and velocity of the user's motion captured in the pictures.

Although some examples of behavior patterns have been described in the above embodiments, the behavior patterns extracted by the input unit 1120 of the mobile terminal 1100 are not limited thereto, but may include any information representing behavioral characteristics of a user other than physiological characteristics such as finger print, irises and voice tone.

Referring back to FIG. 2, the authentication unit 1140 of the mobile terminal 1100 transmits the inputted authentication information and behavior patterns extracted based on the authentication information to the authentication server 1200 through the data communication unit 1160. As shown in FIG. 2, the authentication server 1200 includes a data communication unit 1220, an authentication unit 1240 for performing user authentication based on the authentication information and/or behavior patterns received through the data communication unit 1220, and an authentication information database 1260 for storing template authentication information and behavior patterns.

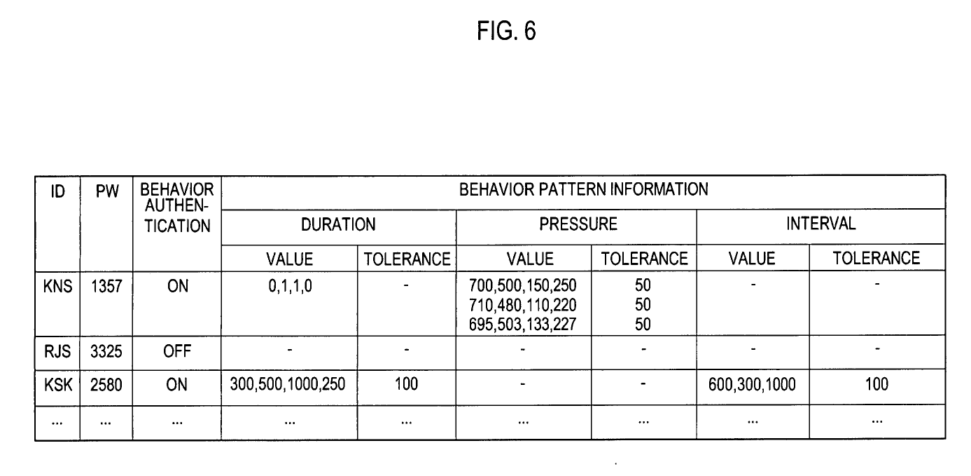

FIG. 6 sets forth an example configuration of authentication information and behavior patterns associated with the authentication information, which are stored in the authentication information database 1260. As shown in FIG. 6, the authentication information database 1260 stores a set of authentication data enrolled for each user, including an ID, a password, a behavior authentication flag to indicate whether behavior patterns are used in performing user authentication, and relevant behavior pattern information. In an enrollment stage, which will be described later in detail, if a user chooses to use behavior patterns in user authentication, the behavior authentication flag is set to ON, and behavior patterns extracted from authentication information are stored in the authentication information database 1260.

As shown in FIG. 6, the behavior pattern information may include a tolerance value for behavior patterns. The tolerance value (i.e., margins of error) may be used in user authentication in such a way as follows. That is, if a difference between test behavior patterns (extracted from authentication information inputted by a user) and template behavior patterns (stored in the authentication information database 1260) is less than the tolerance value, the claimed identify of the user is verified. For example, as shown in FIG. 6, a user having an ID “KSK” has chosen to use two typing patterns, i.e., duration and interval, as behavior patterns while setting a tolerance value for each of the typing patterns. In an enrollment stage, a user may set a different tolerance value for each of typing patterns. Further, a tolerance value may be represented in the same unit as those of the behavior patterns or may be represented as a rate of the tolerance value to the behavior pattern values.

Further, in an enrollment stage, more than one set of behavior patterns may be generated by inputting authentication information repeatedly more than once for each user. In this case, the entire sets of behavior patterns may be stored as template behavior patterns in the authentication information database 1260. Alternatively, a representative value, e.g., an average of the entire sets of behavior patterns may be stored in the authentication information database 1260.

In one embodiment, the template behavior patterns stored in the authentication information database 1260 may be updated whenever a user authentication process is performed. For example, if a claimed identify of a user is verified in a user authentication process, test behavior patterns used in the user authentication process may replace the template behavior patterns (e.g., least recently enrolled template behavior patterns) stored in the authentication information database 1260 or may be additionally enrolled in the authentication information database 1260.

As shown in FIG. 2, in an authentication stage, the authentication unit 1240 of the authentication server 1200 performs user authentication by comparing the test authentication information and/or behavior patterns received from the data communication unit 1220 with those stored in the authentication information database 1260. For example, the authentication unit 1240 may retrieve data stored in the authentication information database 1260 using an ID included in the test authentication information as a keyword. If the ID is not found in the authentication information database 1260, the user authentication fails and then the authentication server 1200 may send a request for enrolling new authentication information to the mobile terminal 1100. On the other hand, if the ID is found in the authentication information database 1260, the user authentication is performed by comparing the test authentication information (i.e., password) and/or behavior patterns with those stored in the authentication information database 1260.

In the authentication stage, the test behavior patterns may be compared with those stored in the authentication information database 1260 to check if a difference therebetween falls within a predetermined tolerance. In this case, the tolerance value may be determined differently depending on the security level required in the authentication system. For example, the smaller the tolerance value is set to be, the higher security level can be maintained in the authentication system. As mentioned above, the authentication information database 1260 may include tolerance values associated with template behavior patterns.

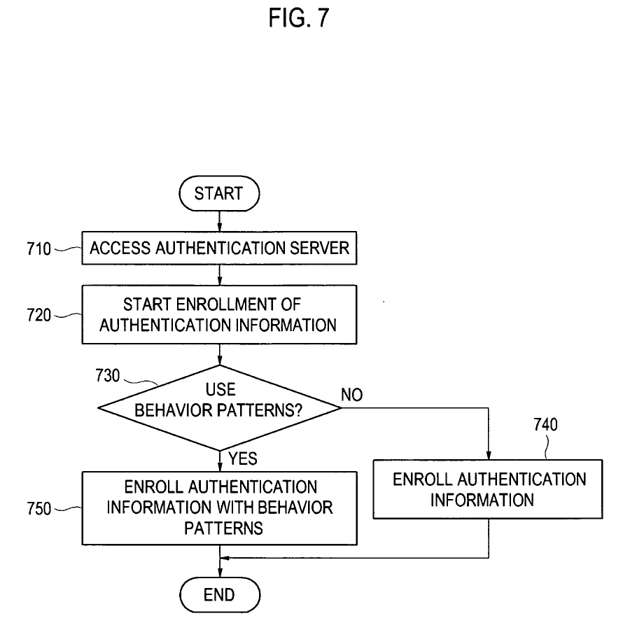

In the ensuing discussion, various embodiments of a method for enrolling authentication information and performing user authentication based on behavior patterns extracted based on authentication information will be described in detail with reference to FIGS. 7 to 10.

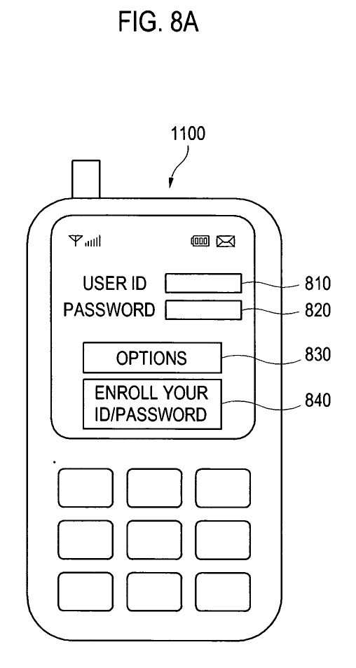

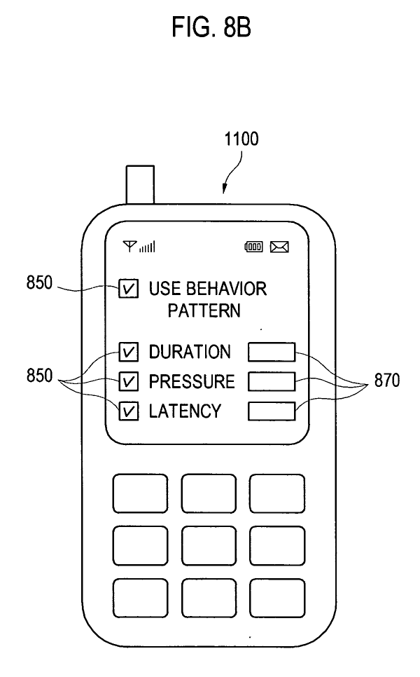

FIG. 7 describes a flowchart of a method for enrolling authentication information and behavior patterns in an authentication system in accordance with one embodiment of the present disclosure. In an enrollment stage, a user takes a step for enrolling his/her authentication information including an ID and a password in an authentication system. Further, the user may selectively enroll behavior patterns associated with the authentication information. Particularly, when a mobile terminal accesses an authentication server, the authentication server sends to the mobile terminal a request for displaying a user interface for inputting authentication information (operation 710). In response to the request from the authentication server, the mobile terminal displays a user interface for inputting authentication information. For example, as shown in FIG. 8A, the mobile terminal 1100 displays windows 810 and 820 for inputting an ID and a password, respectively, and a button 840 for starting the enrollment of authentication information and/or relevant behavior patterns. Then, the user inputs his/her authentication information and starts enrolling the authentication information (operation 720). For example, the user may input an ID and a password in the windows 810 and 820, respectively, and select the button 840 to start enrolling the authentication information. Further, the user may select one or more options on whether behavior patterns are to be extracted from the authentication information and/or on a type of behavior patterns. For example, if the user selects an option button 830, the mobile terminal displays a user interface for selecting various options for behavior patterns, as shown in FIG. 8B. As shown, the user may select a check button 850 to indicate that behavior patterns are to be extracted from the authentication information. Further, the user may determine which type of behavior patterns are to be used and/or the size of tolerance values associated with the behavior patterns. For example, as shown in FIG. 8B, in case typing patterns are used as the behavior patterns, the user may select at least one of check buttons 860 to choose which of duration, pressure and latency to be used as the behavior pattern, and input corresponding tolerance values in windows 870. In one embodiment, the user may determine whether the behavior patterns are quantized in a certain resolution depending on the level of security required in the authentication system. Further, although various options for the use of behavior patterns have been described to be determined by the user in FIGS. 8A and 8B, such options may be pre-determined or automatically determined by the authentication system.

In operation 720, if the user starts enrolling the authentication information, the mobile terminal checks if behavior patterns are to be extracted from the authentication information (operation 730). If the user chooses not to use behavior patterns in user authentication, only the authentication information is enrolled in the authentication server (operation 740). For example, if the user presses the button 840 without checking the button 850 (i.e., in case behavior patterns are not to be used in user authentication), the behavior patterns are not extracted from the inputted authentication information and only the authentication information is enrolled in the authentication server. On the other hand, if the user chooses to use behavior patterns, relevant behavior patterns are extracted based on the inputted authentication information and enrolled in the authentication server (operation 750). For example, if the user presses the button 840 for enrolling authentication information with the button 850 being checked, the authentication information inputted by the user, e.g., in the form of keystrokes, motions, voice, signatures or images, as described above with reference to FIGS. 3 to 5, is processed to extract relevant behavior patterns.

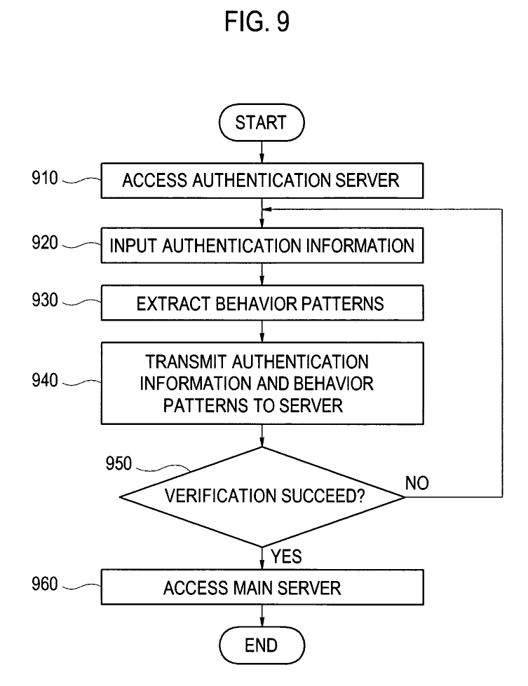

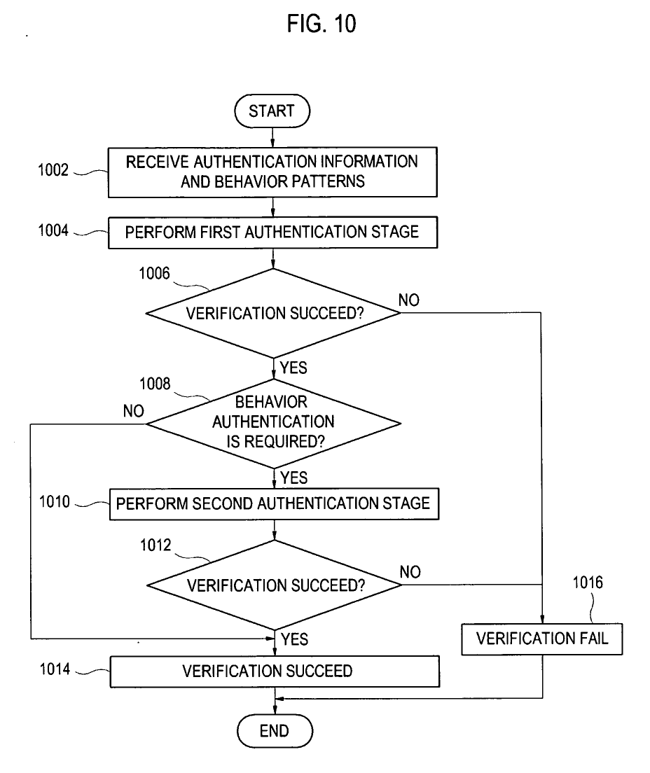

FIGS. 9 and 10 depict a flowchart of a method for performing user authentication in accordance with one embodiment of the present invention. FIG. 9 shows operations for receiving authentication information and extracting behavior patterns, which may be performed in a mobile terminal of a user, while FIG. 10 shows operations for performing user authentication based on the authentication information and behavior patterns, which may be performed in an authentication server.

As shown in FIG. 9, if a user accesses an authentication server through a mobile terminal, the mobile terminal requests a user to input authentication information including an ID and a password, e.g., as shown in FIG. 8A (operation 910). Then, if a user inputs authentication information (operation 920), the mobile terminal extracts behavior patterns based on the inputted authentication information (operation 930), and transmits the authentication information and the extracted behavior patterns to an authentication server (operation 940).

In response to the authentication information and the behavior patterns transmitted from the mobile terminal, the authentication server performs user authentication by comparing the received information with those stored in an authentication information database, which will be described in more detail with reference to FIG. 10. If the claimed identity of the user is verified in the authentication server, the authentication server sends a message indicating the verification result to the mobile terminal. If the verification succeeds, the user is allowed to access a main system for providing relevant online service (operations 950 and 960). Otherwise, if the verification fails, the user may be requested to retry inputting authentication information through the mobile terminal (operations 950 and 920).

FIG. 10 presents operations for performing user authentication based on the authentication information and behavior patterns sent from a mobile terminal in an authentication server. As shown in FIG. 10, if the authentication server receives test authentication information and behavior patterns from a mobile terminal (operation 1002), the authentication server performs user authentication by comparing the test authentication information and/or behavior patterns with those stored in an authentication information database.

In one embodiment, the authentication server performs two stages of user authentication processes as follows. At a first authentication stage, the authentication server compares the test authentication information with those stored in the authentication information database (operation 1004). If the verification of the claimed identity fails in the first authentication stage (operations 1006 and 1016), the authentication server may send to the mobile terminal a request for retry inputting authentication information. On the other hand, if the verification succeeds, the authentication server checks whether a behavior authentication is required (operation 1008), e.g., by referring to a behavior authentication flag stored in the authentication information database, as described above. If it is determined that the behavior authentication is not required, the verification is completed (operation 1014). In this case, the user may be allowed to access a main system for providing relevant online service. Otherwise, if it is determined the behavior authentication is required, the authentication server performs a second user authentication by comparing the test behavior patterns with those stored in the authentication information database (operation 1010). In operation 1012, if it is determined that the verification succeeds (operation 1014), the user may be allowed to access a main system; otherwise, if it is determined that the verification fails (operation 1016), the authentication server may send to the mobile terminal a request for retry inputting authentication information.

In a user authentication stage, the authentication server may employ any suitable pattern matching algorithm such as Euclidean distance metric in comparing test authentication information and behavior patterns with those stored in the authentication information database. Alternatively, the authentication server may employ any other type of pattern matching or recognition algorithms such as neural network, support vector machine and genetic algorithm in the user authentication process.

While the present disclosure have been described in particular embodiments, it should be appreciated that such embodiments can be implemented in hardware, software, firmware, middleware or a combination thereof and utilized in systems, subsystems, components or sub-components thereof. When implemented in software, the elements of the embodiments are the instructions/code segments for performing the necessary tasks. The program or code segments can be stored in a computer readable medium, such as a processor readable medium or a computer program product. Alternatively, they can be transmitted by a computer data signal embodied in a carrier wave, or a signal modulated by a carrier, over a transmission medium or communication link. The computer-readable medium or processor-readable medium may be any type of medium, which can store or transfer information in a form that is readable and executable by a machine (e.g., processor, computer, etc.).

What is claimed is:

1. A mobile terminal comprising:
an input unit configured to receive authentication information of a user;
an authentication unit configured to extract behavior patterns based on the authentication information; and
a data communication unit configured to transmit the authentication information and the behavior patterns to an authentication server,
wherein the authentication server is configured to verify an identity of the user by comparing at least one of the authentication information and the behavior patterns with template authentication information and behavior patterns.

2. The mobile terminal of claim 1, wherein the input unit includes a key pad configured to receive keystrokes typed by the user as the authentication information,
wherein the behavior patterns include typing patterns extracted based on the keystrokes.

3. The mobile terminal of claim 2, wherein the typing patterns include at least one of a duration for which the user holds down a key of the key pad, an interval which it takes for the user to type between keys of the key pad, and a pressure at which the user holds down a key of the key pad.

4. The mobile terminal of claim 1, wherein the input unit includes a motion sensor configured to receive signals generated by moving the mobile terminal as the authentication information,
wherein the behavior patterns include motion patterns extracted based on the received signals.

5. The mobile terminal of claim 4, wherein the motion patterns include at least one of a distance, a direction and a velocity of a movement of the mobile terminal.

6. The mobile terminal of claim 4, wherein the motion sensor includes a three-axis magnetic field sensor.

7. The mobile terminal of claim 1, wherein the input unit includes a camera configured to capture an image of the user's motion as the authentication information,
wherein the behavior patterns include motion patterns extracted based on the captured image.

8. The mobile terminal of claim 1, wherein the input unit includes a microphone configured to input the user's voice as the authentication information,
wherein the behavior patterns include voice patterns extracted based on the inputted voice.

9. The mobile terminal of claim 8, wherein the voice patterns include at least one of a length and an intonation of the inputted voice.

10. The mobile terminal of claim 1, wherein the input unit includes a signature input device configured to input the user's signature as the authentication information,
wherein the behavior patterns include script patterns extracted based on the inputted script.

11. The mobile terminal of claim 10, wherein the signature input device includes a touch screen.

12. The mobile terminal of claim 1, wherein the input unit is configured to be connected to the authentication unit through a wireless connection.

13. The mobile terminal of claim 1, wherein the mobile terminal is a personal communication device having wireless communication capability.

14. A system for performing user authentication, comprising:
a database configured to store template authentication information and behavior patterns associated with the template authentication information;
an input unit configured to receive test authentication information and behavior patterns from a mobile terminal of a user; and
an authentication unit configured to verify an identity of the user by comparing at least one of the test authentication information and behavior patterns with the template authentication information and behavior patterns stored in the database.

15. The system of claim 14, wherein the authentication unit performs:
a first authentication stage for verifying an identity of the user by comparing the test authentication information with the template authentication information stored in the database; and
a second authentication stage for verifying an identity of the user by comparing the test behavior patterns with the template behavior patterns stored in the database, if the verification of the identity of the user succeeds in the first authentication stage.

16. A method for enrolling authentication information, comprising:
receiving authentication information from a user;
checking if the user has chosen to use behavior patterns associated with the authentication information in verifying an identity of the user;
if the user has chosen to use the behavior patterns, extracting the behavior patterns based on the authentication information; and
storing the authentication information and the extracted behavior patterns in a database.

17. The method of claim 16, further comprising:
receiving information on the type of the behavior patterns and tolerance values associated with the behavior patterns, wherein the tolerance values to be used as a margin of error in verifying an identity of the user.

18. A method for performing user authentication in a mobile terminal, comprising:
receiving test authentication information from a user of the mobile terminal;
extracting test behavior patterns based on the test authentication information;
requesting for user authentication by transmitting the test authentication information and behavior patterns to an authentication server, wherein the authentication server is configured to verify an identity of the user by comparing at least one of the test authentication information and behavior patterns with template authentication information and behavior patterns; and
receiving a result of the verification from the authentication server.

19. A method for performing user authentication in an authentication server, comprising:
receiving test authentication information and behavior patterns extracted based on the test authentication information from a mobile terminal;
performing a first authentication stage by comparing the test authentication information with template authentication information stored in a database;
if the user authentication succeeds in the first authentication stage, checking if a second authentication stage is required;
if it is determined that the second authentication stage is required, comparing the test behavior patterns with template behavior patterns stored in the database; and
transmitting at least one of results of the first and second authentication stages to the mobile terminal.

20. A computer readable storage medium storing computer executable code segments to instruct a processor of a user authentication system to carry out a method comprising:
receiving authentication information from a user;
checking if the user has chosen to use behavior patterns associated with the authentication information in verifying an identity of the user;
if the user has chosen to use the behavior patterns, extracting the behavior patterns based on the authentication information; and
storing the authentication information and the extracted behavior patterns in a database.

21. A computer readable storage medium storing computer executable code segments to instruct a processor of a user authentication system to carry out a method comprising:
receiving test authentication information from a user of the mobile terminal;
extracting test behavior patterns based on the test authentication information;
requesting for user authentication by transmitting the test authentication information and behavior patterns to an authentication server, wherein the authentication server is configured to verify an identity of the user by comparing at least one of the test authentication information and behavior patterns with template authentication information and behavior patterns; and
receiving a result of the verification from the authentication server.

22. A computer readable storage medium storing computer executable code segments to instruct a processor of a user authentication system to carry out a method comprising:
receiving test authentication information and behavior patterns extracted based on the test authentication information from a mobile terminal;
performing a first authentication stage by comparing the test authentication information with template authentication information stored in a database;
if the user authentication succeeds in the first authentication stage, checking if a second authentication stage is required;
if it is determined that the second authentication stage is required, comparing the test behavior patterns with template behavior patterns stored in the database; and
transmitting at least one of results of the first and second authentication stages to the mobile terminal.
